(19) United States
(12) Patent Application Publication
(10) Pub. No.: US 2020/0301086 A1
(43) Pub. Date: Sep. 24, 2020

(54) Hybrid Cable Usable Downhole

(71) Applicant: Halliburton Energy Services, Inc., Houston, TX (US)

(72) Inventors: Seldon David Benjamin, Spring, TX (US); Jason Edward Therrien, Cypress, TX (US); Mikko Jaaskelainen, Katy, TX (US); Brian Vandellyn Park, Spring, TX (US)

(21) Appl. No.: 16/088,589

(22) PCT Filed: Jun. 13, 2016
(86) PCT No.: PCT/US2016/037137

§ 371 Date: Sep. 26, 2018

(51) Int. Cl. G02B 6/44; E21B 17/20; E21B 47/12

(52) U.S. Cl. CPC G02B 6/4427; E21B 17/206; G02B 6/4416; G02B 6/4484; E21B 47/12

(57) ABSTRACT

A cable for use in a wellbore can include an outer housing and a chamber disposed coaxially within the outer housing. The chamber can have a cross-sectional end length that is substantially the same as an inner diameter of the outer housing. The cable can also include a fiber optic cable disposed in a nonlinear arrangement within the chamber. The cable can also include a conductor disposed adjacent to the chamber within the outer housing. The conductor can be usable for transmitting power to a well tool.

### TECHNICAL FIELD

The present disclosure relates generally to devices for use in well systems. More specifically, but not by way of limitation, this disclosure relates to a hybrid cable usable in a wellbore.

### BACKGROUND

A well system (e.g., an oil or gas well for extracting fluids or gas from a subterranean formation) can include a wellbore. A well tool, such as a tool for detecting one or more environmental conditions in the wellbore, can be positioned in the wellbore. The well tool can be positioned in the wellbore using a cable. For example, the well tool can be attached to an end of the cable. The well tool can be lowered into the wellbore by reeling out the cable from a spool. The well tool can be extracted from the wellbore by reeling in the cable back onto the spool.

Some cables can also be used to transmit power and data to the well tool while the well tool is positioned in the wellbore. For example, the cable can include a wire for transmitting power from a power source, which may be positioned at the well surface, to the well tool. The cable can also include a fiber optic cable for transmitting data from a transmitter (e.g., at the well surface) to the well tool. Cables that include both conductors for transmitting power and fiber optic cables for transmitting data can be referred to as “hybrid cables.” But hybrid cables can be expensive, difficult to manufacture, and easily damaged by the harsh environment in the wellbore.

### BRIEF DESCRIPTION OF THE DRAWINGS

FIG. 1 is a cross-sectional side view of an example of a well system that includes a hybrid cable usable downhole according to some aspects.

FIG. 2 is a cross-sectional side view of an example of a portion of a well system that includes a hybrid cable usable downhole according to some aspects.

FIG. 3 is a cross-sectional end view of an example of a hybrid cable usable downhole according to some aspects.

FIG. 4 is a cross-sectional end view of an example of a hybrid cable that includes multiple fiber optic cables according to some aspects.

FIG. 5 is a cross-sectional side view of an example of a hybrid cable usable downhole according to some aspects.

FIG. 6 is a cross-sectional end view of an example of a hybrid cable that includes ribbon conductors according to some aspects.

FIG. 7 is a cross-sectional end view of an example of a hybrid cable that includes flat conductors according to some aspects.

FIG. 8 is a cross-sectional end view of an example of a hybrid cable that includes different-sized conductors according to some aspects.

FIG. 9 is a cross-sectional end view of an example of a hybrid cable that includes a triangularly shaped chamber according to some aspects.

FIG. 10 is a cross-sectional end view of an example of a hybrid cable that includes an oval shaped chamber according to some aspects.

FIG. 11 is a perspective view of an example of a hybrid cable that includes an oval shaped chamber according to some aspects.

FIG. 12 is a cross-sectional end view of an example of a hybrid cable according to some aspects.

FIG. 13 is a cross-sectional end view of an example of a hybrid cable that includes multiple outer housing layers according to some aspects.

FIG. 14 is a flow chart showing an example of a process for making a hybrid cable usable downhole according to some aspects.

### DETAILED DESCRIPTION

Certain aspects and features of the present disclosure relate to a hybrid cable usable in a wellbore. A hybrid cable includes a fiber optic cable for communicating data to a well tool and a conductor for transmitting power to the well tool. In some examples, there can be excess fiber optic cable disposed in the hybrid cable. For example, rather than extending the fiber optic cable in a straight line from one end of the hybrid cable to another end of the hybrid cable, the fiber optic cable can be positioned in the hybrid cable in a nonlinear arrangement (e.g., a sine wave shape or a coiled shape), so that there is excess fiber optic cable in the hybrid cable. The excess fiber optic cable can prevent the fiber optic cable from breaking or otherwise becoming damaged if the hybrid cable expands or contracts (e.g., due to fluctuations in downhole temperatures). For example, as the hybrid cable expands, the ends of the hybrid cable can move apart from one another. This can cause the ends of the fiber optic cable to move apart from one another. The excess fiber optic cable can provide an allowance or give so that the ends of the fiber optic cable can move apart from one another without the fiber optic cable breaking.

The amount of excess fiber optic cable positionable in the hybrid cable can be based on how the fiber optic cable is arranged in the hybrid cable and the shape of a chamber enclosing the fiber optic cable. The chamber can be positioned and shaped for improving or maximizing the amount of excess fiber optic cable positionable in the hybrid cable. For example, the chamber can include an oval cross-sectional end shape and can be positioned through a cross-sectional center of the hybrid cable. Positioning the chamber through the cross-sectional center of the hybrid cable can allow the chamber to have at least one dimension (e.g., a major axis of the oval) that is substantially the same size as an inner diameter of the hybrid cable. This may allow for more excess fiber optic cable to be positioned in the chamber than if the chamber is positioned elsewhere in the hybrid cable, such as off-center (which may result in none of the dimensions of the chamber being substantially the same size as the inner diameter of the hybrid cable). Some examples can include up to 15% excess fiber length (EFL) in the hybrid cable, which is significantly higher than the 0.5% EFL of typical hybrid cables.

Positioning the chamber through the cross-sectional center of the hybrid cable can also provide for a more robust hybrid cable. For example, in a typical hybrid cable, a fiber optic cable may be positioned off-center in the hybrid cable. When such a typical hybrid cable is wound around a spool (e.g., for storing, transporting, or deploying the hybrid cable), the off-center positioning of the fiber optic cable may result in the fiber optic cable being unevenly positioned around the spool. For example, some portions of the fiber optic cable may be radially closer to a central axis of the spool and other portions of the fiber optic cable may be radially farther from the central axis of the spool. This uneven positioning around the spool can result in varying tensions on the fiber optic cable, which can result in damage to the fiber optic cable, affect the optical quality of the fiber optic cable, or both. Further, each of these typical hybrid cables can be wrapped around a spool slightly differently, with different tensions on and bends in the fiber optic cable, resulting in different optical characteristics. This can make it challenging to assess the quality of the fiber optic cable while the fiber optic cable is on the spool. But some examples of the present disclosure overcome these weaknesses by positioning the fiber optic cable in the cross-sectional center of the hybrid cable, so that the fiber optic cable is uniformly positioned around a spool.

In some examples, the hybrid cable includes a conductor positioned adjacent to the chamber in the hybrid cable. The conductor can be usable for transmitting power from a power source to a well tool coupled to the hybrid cable. Some hybrid cables can include multiple conductors of the same type or of different types for providing power to the same or different well tools.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

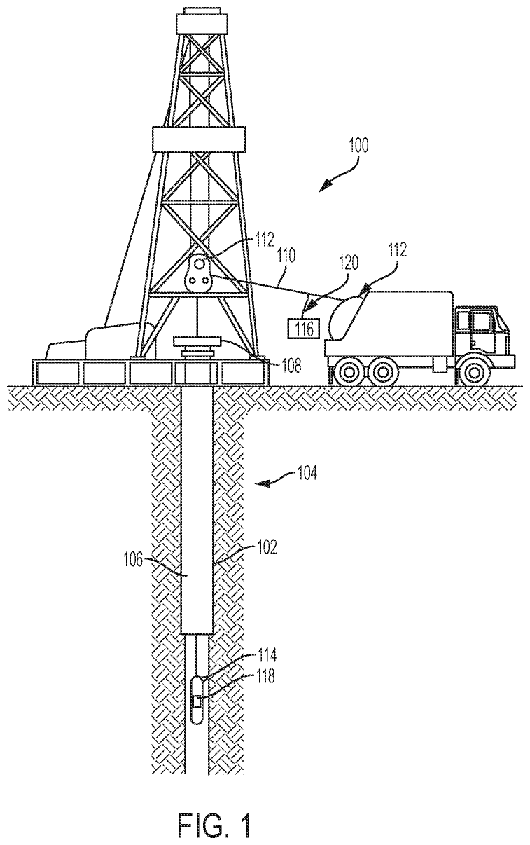

FIG. 1 is a cross-sectional view of an example of a well system 100 that includes a hybrid cable 110 according to some aspects. In the example shown in FIG. 1, the well system 100 includes a wellbore 102 extending through a hydrocarbon bearing subterranean formation 104. A casing string 106 (e.g., a metal casing) extends from the well surface 108 into the subterranean formation 104. The casing string 106 can provide a conduit via which formation fluids, such as production fluids produced from the subterranean formation 104, can travel from the wellbore 102 to the well surface 108.

The well system 100 can also include a well tool 114 (e.g., a formation testing tool, a logging while drilling tool, or a reservoir monitoring tool). In some examples, the well tool 114 can include a fluid monitoring tool, a cement monitoring tool, a multi-phase flow monitoring system, a valve, a gauge, a sensor (e.g., a sensor for detecting pressure, strain, temperature, fluid density, fluid viscosity, acoustic vibrations, a chemical, an electric field, a magnetic field, or another parameter), an optical device or system, or any combination of these.

The well tool 114 can be positioned in the wellbore via the hybrid cable 110. For example, the well tool 114 can be lowered into the wellbore 102 by manipulating a winch 112 or pulley, unreeling the hybrid cable 110 from a spool 122, or both. In some examples, the hybrid cable 110 can also be extracted or removed from the wellbore 102 (e.g., to remove the well tool 114 from the wellbore 102). For example, the hybrid cable 110 can be extracted from the wellbore 102 by reeling the cable onto the spool 122.

The hybrid cable 110 can include one or more conductors. The conductors can be used for transmitting power to the well tool 114. For example, the hybrid cable 110 can include one or more wires that electrically couple one or more power sources at the well surface 108 to the well tool 114. The conductors can additionally or alternatively be used for communicating data between the well tool 114 and the well surface 108.

The hybrid cable 110 can also include one or more fiber optic cables. The fiber optic cables can be used for communicating data between an optical device 116 (e.g., at the well surface 108 or elsewhere in the well system 100) and the well tool 114. For example, the optical device 116 can transmit data encoded in optical signals to another optical device 118 positioned in the well tool 114 via the hybrid cable 110. The optical device 118 of the well tool 114 can receive the optical signals and determine the data from the optical signals. As another example, the well tool 114 can transmit data encoded in optical signals to the optical device 116 via the hybrid cable 110. The optical device 116 can receive the optical signals and determine the data from the optical signals. In this manner, two-way communication between the optical devices 116, 118 can be achieved.

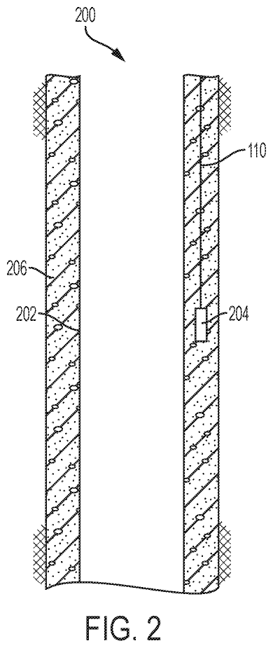

FIG. 2 is a cross-sectional view of an example of a portion of a well system 200 that includes a hybrid cable 110 usable downhole according to some aspects. The well system 200 includes a wellbore 202 drilled from a subterranean formation. The wellbore 202 can be cased and cemented 206. The well system 200 can also include other well components (not shown for clarity), such as one or more well tools, valves, sensors, drill strings, etc.

The hybrid cable 110 can be positioned in any suitable location in the wellbore 202. In some examples, the hybrid cable 110 can be permanently positioned in the wellbore 202. For example, the hybrid cable 110 may be positioned in or on the cement casing 206. Additionally or alternatively, the hybrid cable 110 can be coupled to a casing string or another portion of the wellbore 202.

In some examples, the hybrid cable 110 can be electrically coupled to an electronic device 204 for transmitting power, data, or both to the electronic device 204. The electronic device 204 can be coupled to the cement casing 206 or positioned elsewhere in the well system 200. Some examples of the electronic device 204 can include the optical device 118 of FIG. 1 or a sensor, such as a temperature sensor or another sensor. The electronic device 204 can receive the power, data, or both from via the hybrid cable 110 and perform one or more functions based on the power, data, or both. Additionally or alternatively, the hybrid cable 110 can itself act as a sensor. For example, a fiber optic cable of the hybrid cable 110 can be part of a distributed acoustic sensing (DAS) system.

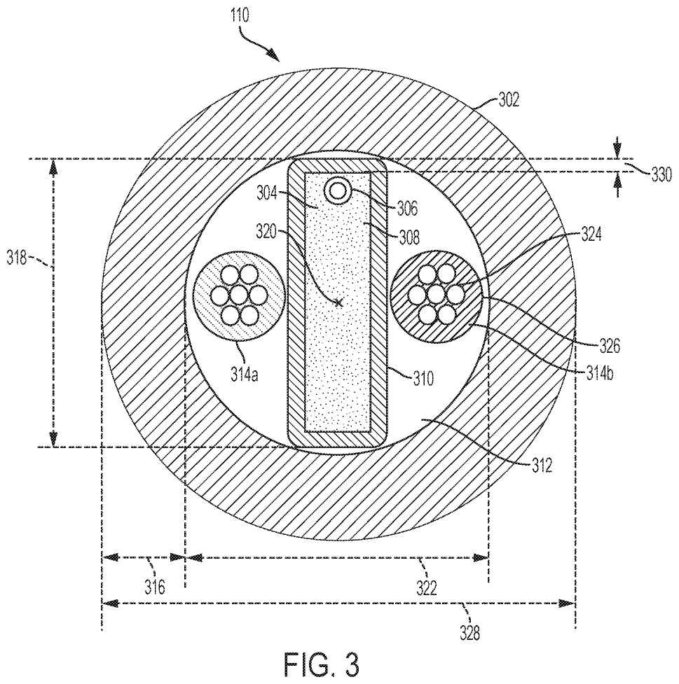

FIG. 3 is a cross-sectional end view of an example of a hybrid cable 110 usable downhole according to some aspects. The hybrid cable 110 includes an outer housing 302. The outer housing 302 can enclose and position the components internal to the hybrid cable 110. In some examples, the outer housing 302 can protect components internal to the hybrid cable 110 against harsh downhole conditions, such as high (or fluctuating) pressures and temperatures. As a particular example, the outer housing 302 may be able to withstand temperatures up to 250° C. The outer housing 302 can additionally or alternatively protect components internal to the hybrid cable 110 against corrosive or otherwise detrimental fluids, such as brine, hydrocarbons, carbon dioxide, hydrogen sulfide, water, or any combination of these. In some examples, the outer housing 302 can protect components internal to the hybrid cable 110 against impacts, such as impacts with another cable, a well tool, a portion of the wellbore, or any combination of these. The outer housing 302 can include metal, plastic, or another material or combination of materials suitable for performing the above-described protective functions.

In some examples, the outer housing 302 can partially or completely support the weight of a well tool (e.g., coupled to an end of the hybrid cable 110). For example, the well tool can be affixed to the outer housing 302 of the hybrid cable 110 for supporting the weight of the well tool when the well tool is positioned in a wellbore. In such an example, the outer housing 302 can include one or more materials of sufficient durability and strength to support the weight of a well tool. For example, the outer housing 302 can include a material capable over holding up to 12,000 pounds (lbs) of force without breaking.

The outer housing 302 can have any suitable thickness 316 for performing the protective and support functions described above. For example, the outer housing 302 can have a thickness 316 of between 0.635 millimeters (mm) and 1.651 mm. As a particular example, the outer housing 302 can have a thickness 316 of 1.2446 mm, which can result in a stronger hybrid cable 110 that is capable of being used in a higher-pressure environment than a hybrid cable 110 with a thinner outer housing 302. In some examples, the outer housing 302 can have an outer diameter 328 of 8 mm.

The hybrid cable 110 can include a chamber 304 disposed within the outer housing 302. The chamber 304 can extend through an entire longitudinal length of the hybrid cable 110. For example, the chamber 304 and extend from one end of the hybrid cable 110 to another end of the hybrid cable 110. In some examples, the chamber 304 can be formed by a container 310. The container 310 can include metal (e.g., stainless steel), plastic, or any other suitable material for forming the chamber 304 within the hybrid cable 110. In some examples, the container 310 can include a thickness 330 of 0.035 mm. The thicker the container 310, the greater the ability of the container 310 to retain the shape of the chamber 304 under extreme downhole pressures.

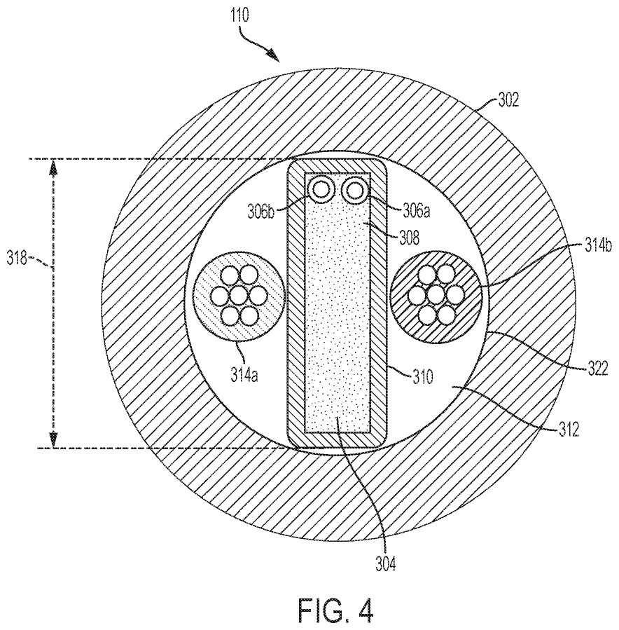

The chamber 304 can include a fiber optic cable 306. The fiber optic cable 306 can extend through the longitudinal length of the hybrid cable 110. For example, the fiber optic cable 306 can extend from one end of the hybrid cable 110 to another end of the hybrid cable 110 (e.g., for transmitting data from an electronic device at one end of the hybrid cable 110 to another electronic device at another end of the hybrid cable 110). Although one fiber optic cable 306 is shown in FIG. 3, the chamber 304 can include any number of fiber optic cables. For example, as shown in FIG. 4, the chamber 304 can include two fiber optic cables 306a-b.

The chamber 304 can include one or more materials, such as material 308. The material 308 can include a gel, such as a sepigel. In some examples, the material 308 can position the fiber optic cable 306 within the chamber 304. For example, the material 308 can maintain the positioning and configuration of the fiber optic cable 305 within the chamber 304. The material 308 can additionally or alternatively perform one or more protective functions. For example, the material 308 can act as a hydrogen scavenger, removing hydrogen from the chamber 304 or absorbing hydrogen before the hydrogen can interact with the fiber optic cable 306, which could potentially damage the fiber optic cable 306.

The chamber 304 (or the chamber 304 in conjunction with the surrounding container 310) can include any suitable cross-sectional end length 318. For example, the chamber 304 can include a cross-sectional end length 318 of between 3.0 mm and 5.0 mm. As another example, the cross-sectional end length 318 can be substantially the same as an inner diameter 322 of the outer housing 302. The cross-sectional end length 318 can be substantially the same as the inner diameter 322 if the cross-sectional end length 318 is within 0.1 mm of the inner diameter 322. For example, the cross-sectional end length 318 can be substantially the same as the inner diameter 322 if the cross-sectional end length 318 is 4.0 mm and the inner diameter 322 is 4.1 mm. As discussed in greater detail below, the larger the cross-sectional end length 318, the more fiber optic cable 306 can be positioned in the chamber 304.

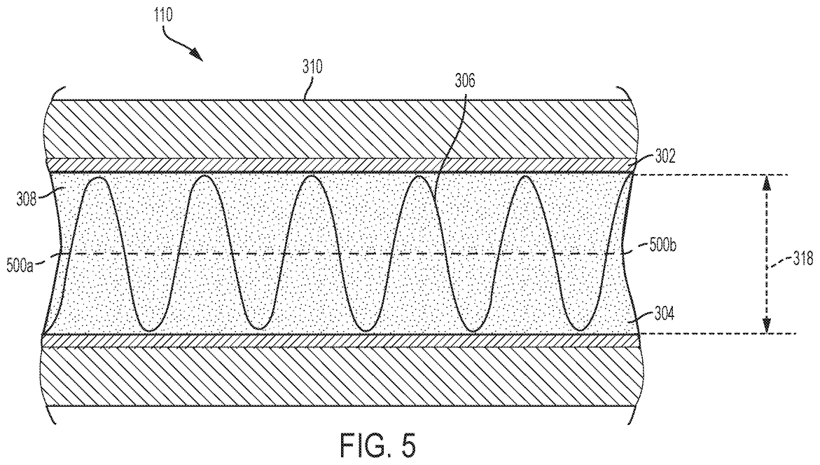

Referring now to FIG. 5, in some examples, the fiber optic cable 306 can be disposed in the chamber 304 in a nonlinear arrangement, such as a sine wave shape, rather than the fiber optic cable 306 extending directly (e.g., in a straight line) from one end 500a of the hybrid cable 110 to the other end 500b of the hybrid cable 110, as shown by the dashed line. In some examples, the period of the sine wave shape can be between 14.0 mm and 17.0 mm. Disposing the fiber optic cable 306 in the chamber 304 in the sine wave shape can allow for excess fiber optic cable to be positioned between the ends 500a-b of the hybrid cable 110. Some examples can yield an EFL of between 1% and 15%, based on how the fiber optic cable 306 is disposed in the chamber 304 and the cross-sectional end length 318 of the chamber 304. For example, if the outer housing 302 has an outer diameter of 6.35 mm, the container 310 has a thickness of 0.035 mm, the fiber optic cable 306 is disposed in the chamber 304 in a sine wave shape having a period of 15.8 mm, and the cross-sectional end length 318 of the chamber 304 is 4.0 mm, an EFL of up to 14% can be achieved.

It can be desirable to include as much excess fiber optic cable 306 in a hybrid cable 110 as possible, as EFL can help reduce or prevent against damage to the fiber optic cable 306. For example, a typical hybrid cable may include a fiber optic cable that extends in a straight line from one end of the hybrid cable to the other end of the hybrid cable, as shown by the dashed line. But if such a hybrid cable expands (e.g., due to downhole temperature changes, transportation to or from a well site, or for another reason), the ends of the fiber optic cable can be pulled apart, increasing the tension on the fiber optic cable. The increased tension on the fiber optic cable may cause the fiber optic cable to stretch, break, or otherwise become damaged. Conversely, in hybrid cables 110 of the present disclosure, the excess fiber optic cable in the chamber 304 can allow for the hybrid cable 110 to expand, without substantially increasing the tension on the fiber optic cable 306, thereby preventing against damage. The more excess fiber optic cable in the hybrid cable 110, the more the hybrid cable 110 can be bent, flexed, or otherwise deformed without damaging the fiber optic cable 306, resulting in a more robust hybrid cable 110.

As discussed above, some examples can include multiple fiber optic cables. The multiple fiber optic cables can be disposed in the chamber 304 in the same arrangement or different arrangements from one another. For example, if the hybrid cable 110 includes two fiber optic cables, one of the fiber optic cables can be disposed linearly through the hybrid cable 110 and the other fiber optic cable 306 can be disposed nonlinearly through the hybrid cable 110. As another example, if the hybrid cable 110 includes two fiber optic cables, one fiber optic cable can be disposed in the hybrid cable 110 in a sine wave shape and the other fiber optic cable 306 can be disposed in the hybrid cable 110 in a coiled shape. As still another example, if the hybrid cable 110 includes two fiber optic cables, one fiber optic cable can be disposed in the hybrid cable 110 in a sine wave shape having a first period and the other fiber optic cable 306 can be disposed in the hybrid cable 110 in a sine wave shape having a second period.

Referring now back to FIG. 3, the chamber 304 can be positioned in (or through) the cross-sectional center of the hybrid cable 110. For example, the chamber 304 can be positioned at least partially through (e.g., symmetrically around) a central axis 320 of the hybrid cable 110. This can leave room on either side of the chamber 304 for one or more conductors 314a-b to be positioned in the hybrid cable 110. For example, one conductor 314a can be positioned on one side of the chamber 304 and adjacent to the chamber 304, and another conductor 314b can be positioned on another side of the chamber 304 and adjacent to the chamber 304.

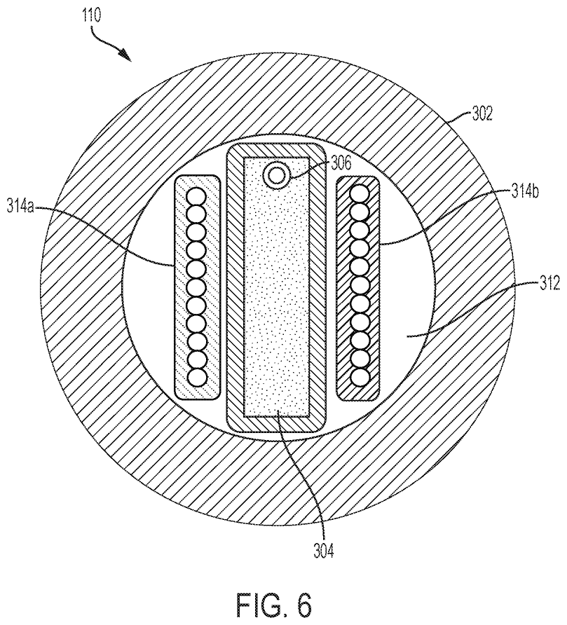

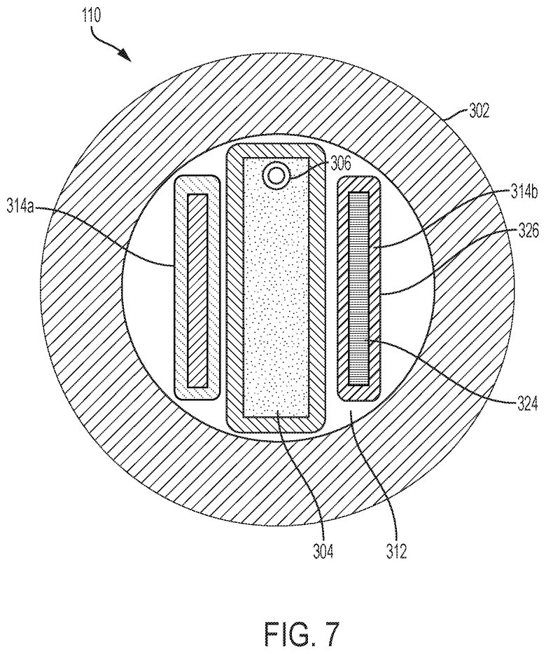

The conductors 314a-b can each include one or more wires, such as wire 324. The wires can include an electrically conductive material, such as copper. One or more of the wires can have a diameter of 2.053 millimeters or more (e.g., corresponding to an American Wire Gauge (AWG) of 12 or more). The wires can be wound, twisted, intertwined, or otherwise integrated through a longitudinal length of the conductor 314a-b. In some examples, the conductor 314a-b can include an outer housing 326 for positioning the wires, protecting the wires, electrically insulating the wires, or any combination of these. In one example shown in FIG. 6, the conductors 314a-b can include ribbon conductors. In another example shown in FIG. 7, the conductors 314a-b can be flat conductors.

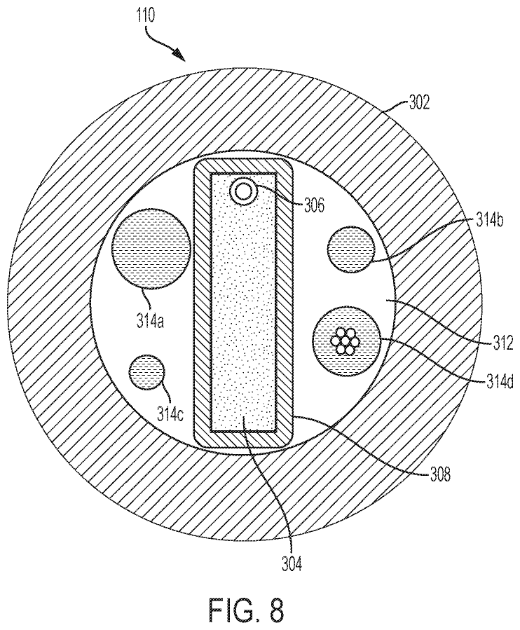

The hybrid cable 110 can include any number and combination of conductors 314a-b. For example, although the conductors 314a-b are depicted in FIGS. 3-7 as being the same as one another, the conductors 314a-b can alternatively be different types, shapes, sizes, and can include different materials from one another. For example, conductor 314a can include a ribbon conductor and conductor 314b can include a flat conductor. As a particular example, as shown in FIG. 8, the hybrid cable 110 can include four different-sized conductors 314a-d. At least two of the conductors 314a-d can be of different types from one another (e.g., conductor 314d is of a different type than conductors 314a-c). Including conductors 314a-b with different characteristics (e.g., type, size, shape, material, diameter, etc.) in the hybrid cable 110 may allow a single hybrid cable 110 to be used with different electronic devices, which may each require different amounts of power, different types of power (e.g., alternating current versus direct current), different conductor connections, or any combination of these. Additionally or alternatively, including conductors 314a-b with different characteristics can allow each of the conductors 314a-b to serve a different purpose. For example, one conductor 314a can be for providing power to a well tool while another conductor 314b can be for communicating data to the well tool.

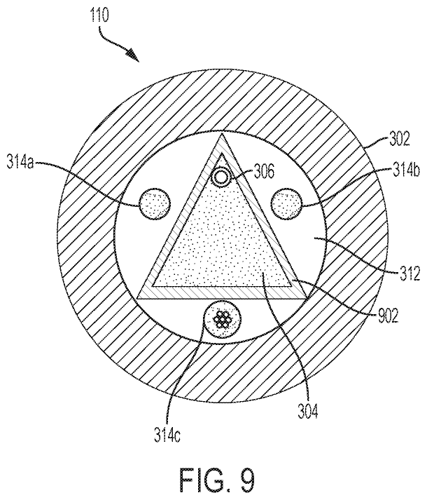

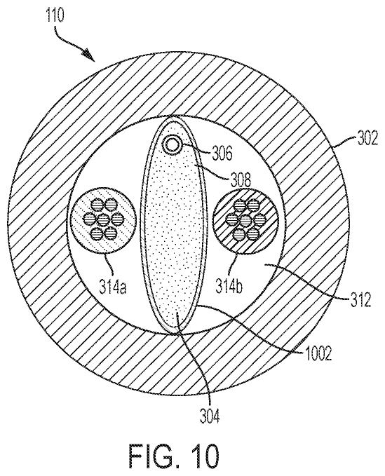

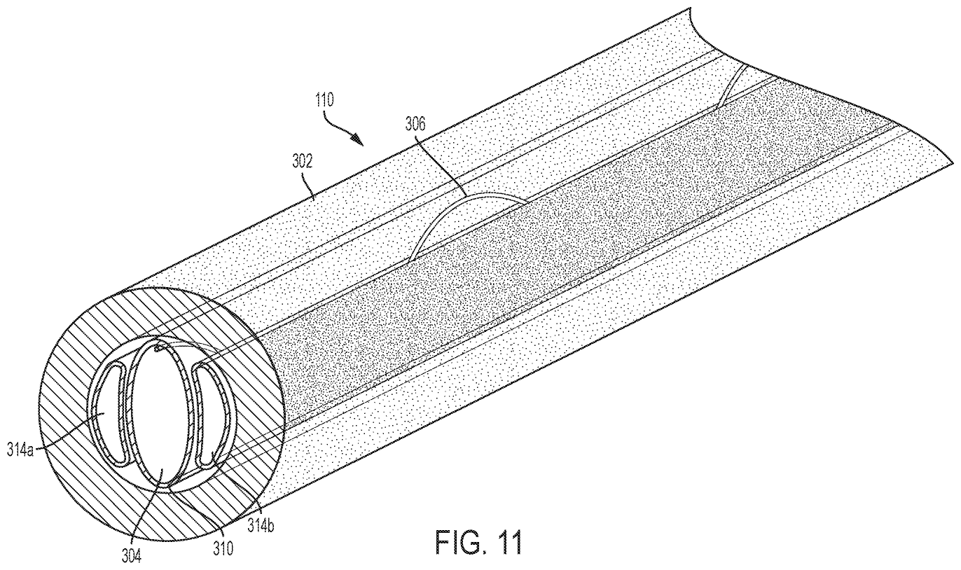

The chamber 304 (e.g., the chamber 304, the container 310 surrounding the chamber, or both) can have any suitable cross-sectional end shape. Different cross-sectional end shapes can allow for different amounts of excess fiber optic cable to be disposed in the chamber 304. For example, the chamber 304 can have a substantially circular or rectangular cross-sectional end shape. As another example, referring to FIG. 9, the chamber 304 can include a triangular cross-sectional end shape. The triangular cross-sectional end shape can be formed by a triangle-shaped container 902. In another example shown in FIG. 10, the chamber 304 can include an oval cross-sectional end shape. The oval cross-sectional end shape can be formed by an oval-shaped container 1002. In some examples, the conductors 314a-b can be shaped to conform around a cross-sectional end shape of the chamber 304. For example, as shown in FIG. 11, the conductors 314a-b include a crescent cross-sectional end shape for conforming around an oval cross-sectional end shape of the chamber 304.

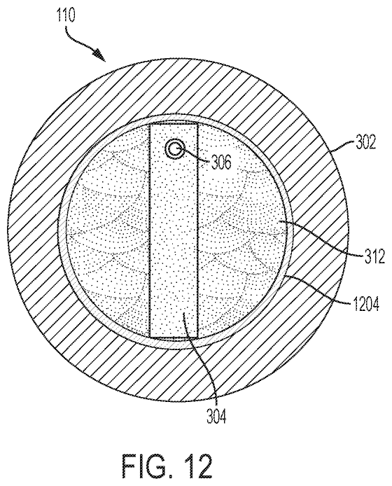

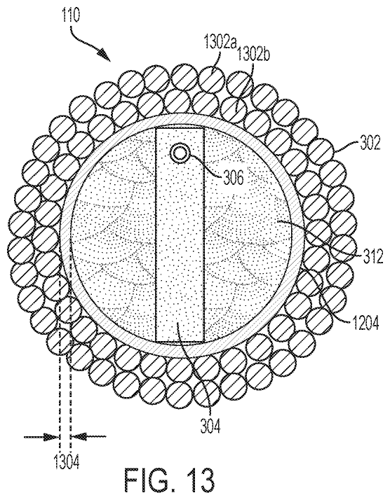

Turning now to FIGS. 12-13, in some examples, the hybrid cable 110 can include one or more materials 312 surrounding at least a portion of the chamber 304, a portion of a conductor (e.g., conductor 314a-b), or both. The material 312 can include a gas, such as air; a solid material, such as plastic or metal; a gel; or any combination of these. The material 312 can position the other components (e.g., the container 310 and conductors 314a-b) within the outer housing 302. The material 312 can additionally or alternatively define the shape of the chamber 304 (e.g., in examples that exclude a container).

In some examples, the material 312 can include a conductive material (e.g., copper). This may allow for the material 312 to be used as a conductor for the hybrid cable 110 additionally or alternatively to other conductors, such as conductors 314a-b of FIG. 3. An insulating layer 1204 may be positioned between an outer diameter of the material 312 and an inner diameter of the outer housing 302 for electrically insulating the material 312 from the outer housing 302.

In one example, the hybrid cable 110 can include an outer housing 302 with an outer diameter of 8.0 mm. The insulating layer 1204 can include a thickness 1304 of 0.8 mm. The material 312 can surround the chamber 304 and form a 2.4 mm conductor with a surface area (not including the chamber 304) of 3.5 mm², which can correspond to wire having an AWG size of 12. This may be larger than a conductor in a typical hybrid cable, and therefore may allow for more power to be transmitted through the hybrid cable 110. Thus, such a hybrid cable 110 may be particularly useful for high-power applications, such as running a tractor in a deep well (e.g., in which a length of the hybrid cable may be 10 km or greater), where a smaller-sized conductor may be unable to provide sufficient power.

In some examples, the outer housing 302 can include multiple layers of material. For example, as shown in FIG. 13, the outer housing 302 can include multiple layers of wires 1302a-b. Each wire can have a diameter of 1.0 mm. The wires 1302a-b can be braided together or otherwise intertwined. The layers of material can provide enhanced protection against the harsh downhole environment.

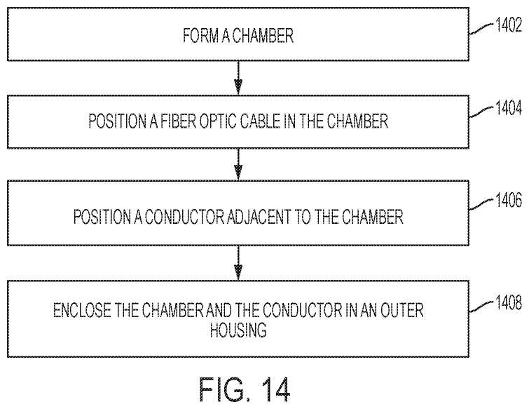

FIG. 14 is a flow chart showing an example of a process for making a hybrid cable usable downhole according to some aspects. One or more of the steps described below can be performed by a human, a manufacturing device, or both.

In block 1402, a chamber is formed. In some examples, the chamber can be formed or defined by a container. For example, a sheet of material (e.g., metal or plastic) can be bent into a hollow tube usable as the container. The hollow interior of the tube can be the chamber.

The chamber can be formed to have any desired cross-sectional end shape. For example, a sheet of material can be passed through one or more rollers or dies to manipulate the cross-sectional end shape of the tube (and thus the chamber) into a desired shape. For example, the tube can be compressed between two or more surfaces (e.g., rollers) to form an oval cross-sectional end shape for the chamber. This can be a fairly easy, cheap, and quick manufacturing process, as opposed to creating a chamber having another shape, such as a rectangular or triangular shape.

In some examples, an outer housing (for a hybrid cable) can be passed through a manufacturing device that can deposit layers of material (e.g., metal or plastic) on or in the outer housing for forming the chamber. For example, the manufacturing device can communicate liquefied plastic or metal onto one or more surfaces of the outer housing in a configuration that, when the liquefied plastic or metal solidifies, may form a chamber having a particular cross-sectional end shape.

In some examples, one or more molds can be used to form the chamber. For example, liquefied material can be communicated into a mold. The mold may have a shape configured to form the liquefied material into a hollow container having a particular cross-sectional end shape when the liquefied material dries. The interior of the hollow container can be the chamber.

Any number and combination of these and other techniques can be used to form the chamber.

In block 1404, a fiber optic cable is positioned in the chamber. The fiber optic cable can be positioned nonlinearly within the chamber for providing excess fiber optic cable in the chamber. For example, the fiber optic cable can be positioned in the chamber in a sine wave shape, a coiled shape, or any other suitable shape. The sine wave shape can have a predetermined period. In one example, a manufacturing device can move an arm attached to the fiber optic cable back and forth at a particular rate for positioning the fiber optic cable in the chamber in a sine wave shape having the predetermined period.

Additionally, a material (e.g., a gel) can be positioned in the chamber. For example, the material can be pumped into the chamber or deposited in the chamber. In some examples, the material can maintain the position of the fiber optic cable in the chamber or perform another function, such as removing hydrogen from the chamber or absorbing hydrogen before the hydrogen can interact with the fiber optic cable. This can prevent damage to the fiber optic cable.

In block 1406, a conductor is positioned adjacent to the chamber. For example, a wire can be extracted from a reel or other container and positioned next to the chamber by a manufacturing device. In some examples, multiple conductors can be positioned adjacent to the chamber, such as on either side of the chamber.

In some examples, the conductor can be formed around the chamber or can form the chamber itself. For example, the conductor can be formed by coupling (e.g., welding) together two halves of conductive material around a container including the chamber. As another example, the chamber may be formed by aligning recessed areas extending through two halves of conductive material adjacent to one another and coupling the two halves of the conductive material together.

In block 1408, the chamber and the conductor are enclosed in an outer housing. For example, two halves of the outer housing can be positioned around the chamber (e.g., a container that includes the chamber) and the conductor. The two halves can then be coupled (e.g., welded) together to form a uniform outer housing around the chamber and the conductor. In another example, the outer housing can be hollow. A container that includes the chamber and the conductor can be slid into the interior of the outer housing. Any number and combination of techniques can used to enclose the chamber and the conductor in the outer housing.

Some examples can provide a simplified manufacturing process that yields a higher-quality hybrid cable. For example, the conductor can be positioned in the hybrid cable adjacent to the fiber optic cable in a small number of simple steps, which can reduce errors, can be cost effective, and can reduce the potential for optical degradation of the fiber optic cable. This can result in a higher-quality hybrid cable than other methods, such as intertwining the conductor with the fiber optic cable or wrapping the conductor around the fiber optic cable, which can be time consuming, expensive, difficult, and can degrade optical performance.

In some aspects, a hybrid cable usable downhole is provided according to one or more of the following examples:

### Example #1

A cable for use in a wellbore can include an outer housing having a longitudinal length extending between one longitudinal end of the cable and another longitudinal end of the cable. The cable can include a chamber disposed coaxially within the outer housing and at a cross-sectional center of the outer housing. The chamber can extend through the longitudinal length of the outer housing and have a cross-sectional end length that is substantially the same as an inner diameter of the outer housing. The cable can include a fiber optic cable disposed in a nonlinear arrangement within the chamber and extending through the longitudinal length of the outer housing. The cable can include at least one conductor disposed adjacent to the chamber within the outer housing. The at least one conductor can extend through the longitudinal length of the outer housing for transmitting power to a well tool positionable in the wellbore.

### Example #2

The cable of Example #1 may feature the outer housing including one or more materials for protecting the fiber optic cable against damage at temperatures of up to 250° C. and holding a weight of up to 12,000 pounds.

### Example #3

The cable of any of Examples #1-2 may feature the cross-sectional end length of the chamber being between 3.0 millimeters (mm) and 5 mm, and a thickness of the outer housing being between 0.635 mm and 1.651 mm.

### Example #4

The cable of any of Examples #1-3 may feature the at least one conductor including a first conductor and a second conductor. The first conductor can be positioned adjacent to a first side of the chamber. The second conductor can be positioned adjacent to a second side of the chamber opposite to the first side of the chamber.

### Example #5

The cable of Example #4 may feature the first conductor being of a different type than the second conductor.

### Example #6

The cable of any of Examples #1-5 may feature the chamber being defined by a metal container disposed within the outer housing. The cable can also feature a gel being disposed in the chamber for maintaining a position of the fiber optic cable within the chamber. The chamber can also feature another fiber optic cable being disposed within the chamber and extending through the longitudinal length of the outer housing.

### Example #7

The cable of any of Examples #1-6 may feature the chamber including an oval cross-sectional end shape and the at least one conductor including a crescent cross-sectional end shape.

### Example #8

The cable of any of Examples #1-7 may feature the nonlinear arrangement including a sine wave shape having a period of between 14 mm and 17 mm.

### Example #9

A system can include a well tool usable in a wellbore and a cable coupleable to the well tool. The cable can include a chamber extending through an outer housing of the cable and disposed coaxially about a central axis of the outer housing. The chamber can have a cross-sectional end length that is substantially the same as an inner diameter of the outer housing. The cable can include a fiber optic cable disposed in a nonlinear arrangement within the chamber. The cable can include at least one conductor disposed adjacent to the chamber and extending through the outer housing for electrically coupling a power source to the well tool.

### Example #10

The system of Example #9 may feature the outer housing including one or more materials for protecting the fiber optic cable against damage at temperatures of up to 250° C.

### Example #11

The system of any of Examples #9-10 may feature the outer housing including one or more materials for holding a weight of up to 12,000 pounds.

### Example #12

The system of any of Examples #9-11 may feature the cross-sectional end length of the chamber being between 3.0 mm and 5 mm, and a thickness of the outer housing being between 0.635 mm and 1.651 mm.

### Example #13

The system of any of Examples #9-12 may feature the at least one conductor including a first conductor and a second conductor. The first conductor can be positioned adjacent to a first side of the chamber. The second conductor can be positioned adjacent to a second side of the chamber opposite to the first side of the chamber

### Example #14

The system of any of Examples #9-13 may feature the chamber being defined by a metal container disposed within the outer housing. The system can also feature a gel being disposed in the chamber for maintaining a position of the fiber optic cable within the chamber. The system can also feature another fiber optic cable being disposed in another nonlinear arrangement within the chamber and extending through the outer housing.

### Example #15

The system of any of Examples #9-14 may feature the chamber including an oval cross-sectional end shape and the at least one conductor including a crescent cross-sectional end shape.

### Example #16

The system of any of Examples #9-15 may feature the nonlinear arrangement including a sine wave shape having a period of between 14 mm and 17 mm.

### Example #17

The system of any of Examples #9-16 may feature the cable being coupled to the well tool. The system can also feature the cable and the well tool being positioned in the wellbore.

### Example #18

A method can include positioning a fiber optic cable in a nonlinear arrangement within a chamber formed by a container. The method can also include positioning the container within an outer housing of a cable and coaxially about a central axis of the outer housing. The container can have a cross-sectional end length substantially the same as an inner diameter of the outer housing. The method can also include positioning at least one conductor adjacent to the container and within the outer housing of the cable.

### Example #19

The method of Example #18 may feature disposing the fiber optic cable in the chamber in a sine wave shape to position the fiber optic cable in the nonlinear arrangement within the chamber.

### Example #20

The method of any of Examples #18-19 may feature forming a cross-sectional end shape of the container into an oval shape using one or more rollers or die.

The foregoing description of certain embodiments, including illustrated embodiments, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A cable for use in a wellbore, the cable comprising:
an outer housing having a longitudinal length extending between one longitudinal end of the cable and another longitudinal end of the cable;
a chamber disposed coaxially within the outer housing and at a cross-sectional center of the outer housing, the chamber extending through the longitudinal length of the outer housing and having a cross-sectional end length that is substantially the same as an inner diameter of the outer housing;
a fiber optic cable disposed in a nonlinear arrangement within the chamber and extending through the longitudinal length of the outer housing; and
at least one conductor disposed adjacent to the chamber within the outer housing, the at least one conductor extending through the longitudinal length of the outer housing for transmitting power to a well tool positionable in the wellbore.

2. The cable of claim 1, wherein the outer housing comprises one or more materials for protecting the fiber optic cable against damage at temperatures of up to 250° C. and holding a weight of up to 12,000 pounds.

3. The cable of claim 1, wherein the cross-sectional end length of the chamber is between 3.0 millimeters (mm) and 5 mm, and a thickness of the outer housing is between 0.635 mm and 1.651 mm.

4. The cable of claim 1, wherein the at least one conductor comprises a first conductor and a second conductor, the first conductor being positioned adjacent to a first side of the chamber and the second conductor being positioned adjacent to a second side of the chamber opposite to the first side of the chamber.

5. The cable of claim 4, wherein the first conductor is of a different type than the second conductor.

6. The cable of claim 1, wherein:
the chamber is defined by a metal container disposed within the outer housing;
a gel is disposed in the chamber for maintaining a position of the fiber optic cable within the chamber; and
another fiber optic cable is disposed within the chamber and extends through the longitudinal length of the outer housing.

7. The cable of claim 1, wherein the chamber comprises an oval cross-sectional end shape and the at least one conductor comprises a crescent cross-sectional end shape.

8. The cable of claim 1, wherein the nonlinear arrangement includes a sine wave shape having a period of between 14 mm and 17 mm.

9. A system comprising:
a well tool usable in a wellbore; and
a cable coupleable to the well tool, the cable comprising:
a chamber extending through an outer housing of the cable and disposed coaxially about a central axis of the outer housing, the chamber having a cross-sectional end length that is substantially the same as an inner diameter of the outer housing;
a fiber optic cable disposed in a nonlinear arrangement within the chamber; and
at least one conductor disposed adjacent to the chamber and extending through the outer housing for electrically coupling a power source to the well tool.

10. The system of claim 9, wherein the outer housing comprises one or more materials for protecting the fiber optic cable against damage at temperatures of up to 250° C.

11. The system of claim 9, wherein the outer housing comprises one or more materials for holding a weight of up to 12,000 pounds.

12. The system of claim 9, wherein the cross-sectional end length of the chamber is between 3.0 mm and 5 mm, and a thickness of the outer housing is between 0.635 mm and 1.651 mm.

13. The system of claim 9, wherein the at least one conductor comprises a first conductor and a second conductor, the first conductor being positioned adjacent to a first side of the chamber and the second conductor being positioned adjacent to a second side of the chamber opposite to the first side of the chamber.

14. The system of claim 9, wherein:
the chamber is defined by a metal container disposed within the outer housing;
a gel is disposed in the chamber for maintaining a position of the fiber optic cable within the chamber; and
another fiber optic cable is disposed in another nonlinear arrangement within the chamber and extends through the outer housing.

15. The system of claim 9, wherein the chamber comprises an oval cross-sectional end shape and the at least one conductor comprises a crescent cross-sectional end shape.

16. The system of claim 9, wherein the nonlinear arrangement comprises a sine wave shape having a period of between 14 mm and 17 mm.

17. The system of claim 9, wherein the cable is coupled to the well tool, and the cable and the well tool are positioned in the wellbore.

18. A method comprising:
positioning a fiber optic cable in a nonlinear arrangement within a chamber formed by a container;
positioning the container within an outer housing of a cable and coaxially about a central axis of the outer housing, the container having a cross-sectional end length substantially the same as an inner diameter of the outer housing; and
positioning at least one conductor adjacent to the container and within the outer housing of the cable.

19. The method of claim 18, wherein positioning the fiber optic cable in the nonlinear arrangement within the chamber comprises disposing the fiber optic cable in the chamber in a sine wave shape.

20. The method of claim 18, further comprising forming a cross-sectional end shape of the container into an oval shape using one or more rollers or die.
